(19) United States
(12) Patent Application Publication
(10) Pub. No.: US 2007/0104885 A1
(43) Pub. Date: May 10, 2007

(54) Method for hot dip coating a metal bar and method for hot dip coating

(76) Inventors: Hans-Georg Hartung, Pulheim (DE); Bernhard Tenckhoff, Duisburg (DE); Rolf Brisberger, Spielberg (AU); Holger Behrens, Erkrath (DE); Klaus Frommann, Dusseldorf (DE)

Correspondence Address: FRIEDRICH KUEFFNER, 317 MADISON AVENUE, SUITE 910, NEW YORK, NY, 10017, US

(21) Appl. No.: 10/562,346

(22) PCT Filed: Jun. 8, 2004
(86) PCT No.: PCT/EP04/06147

§ 371 Date: Dec. 19, 2006

(30) Foreign Application Priority Data
Jun. 27, 2003 (DE) 103 29 034.6
Sep. 20, 2003 (DE) 103 43 648.0

(51) Int. Cl. B05D 1/18; H01F 1/00; B05C 3/00

(52) U.S. Cl. 427/431; 427/598; 118/420; 118/429

(57) ABSTRACT

The invention relates to a device for hot dip coating a metal bar (1), especially a steel strip, wherein the metal bar (1) is vertically guided through a container (3) receiving the molten coating metal (2) and through a guide channel (4) which is arranged upstream therefrom. A magnet, especially an electromagnetic inductor (5), is arranged in the region of the guide channel, said magnet generating a magnetic field in order to retain the coating metal (2) in the container (3). The container (3) is provided with molten coating metal (2) by a premelt container (6). The invention also relates to a method for hot dip coating wherein said type of device is used. According to the invention, the premelt container (6) is arranged below the guide channel (4) in order to technically adapt the existing system in a simple, efficient manner.

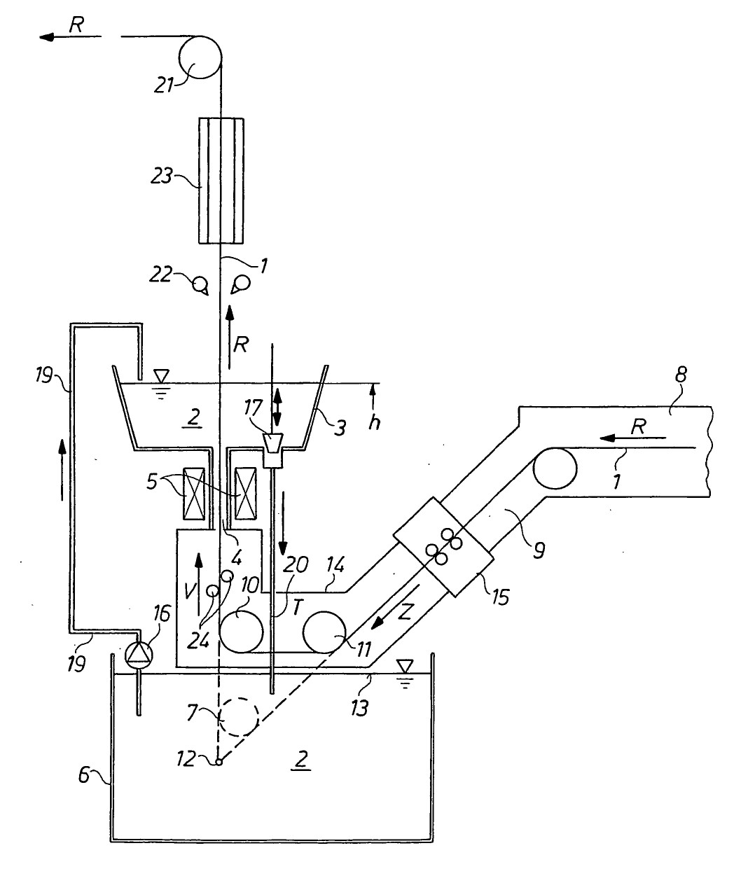

The invention concerns a device and a method for hot dip coating a metal strand, especially a steel strip, with Zn, Al, and Zn—Al alloys, in which the metal strand can be vertically guided through a coating tank that contains the molten coating metal and through a guide channel upstream of the coating tank, wherein electromagnetic inductors are arranged on both sides of the guide channel and induce a magnetic field for keeping the coating metal in the coating tank, and wherein the coating tank is supplied with molten coating metal from a premelting tank.

Previously known metal hot dip coating installations for metal strip have a high-maintenance part, namely, the coating tank and the fittings and fixtures it contains. Before being coated, the surfaces of the metal strip to be coated must be cleaned and activated to allow joining with the coating metal. For this reason, before being coated, the strip is treated in a reducing atmosphere in a continuous furnace. Since the oxide coatings are first removed chemically, the surfaces are activated by the reducing heat-treatment operation in such a way that they are present in pure metallic form after the heat-treatment operation. In this regard, the strip is heated to the temperature necessary for it to be coated with zinc, aluminum, or zinc-aluminum alloys.

However, the activation of the strip surface increases the affinity of the strip surface for the surrounding atmospheric oxygen. To protect the strip surfaces from being exposed to atmospheric oxygen again before the coating operation, the strip is introduced into the hot dip coating bath from above in an immersion snout. Since the coating metal is in a molten state, and one would like to utilize gravitation together with blowing devices (“air squeegee”) to adjust the coating thickness, but the subsequent operations prohibit strip contact until complete solidification of the coating metal has occurred, the strip must be deflected in the vertical direction in the coating tank. This is accomplished with a roller that runs in the molten metal. This roller is subject to strong wear by the molten coating metal and is the cause of shutdowns and thus production losses.

Due to the desired low coating thicknesses of the coating metal, which can be on the order of micrometers, strict requirements must be placed on the quality of the strip surface. This means that the surfaces of the rollers that guide the strip must also be of high quality. Defects in these surfaces generally lead to defects in the surface of the strip. This is another reason for frequent shutdowns of the plant.

To avoid the problems related to the rollers running in the liquid coating metal, there have been approaches that involve the use of a coating tank that is open at the bottom and has a guide channel with a well-defined height in its lower region for guiding the strip vertically upward and that involve the use of an electromagnetic seal to seal the opening. This involves the use of electromagnetic inductors, which operate with electromagnetic alternating or traveling fields, which force the liquid metal back or have a pumping or constricting effect and seal the coating tank at the bottom.

Solutions of this type are described, for example, in EP 0 673 444 B1. The solutions proposed in WO 96/03533 and JP 50[1975]-86446 also involve the use of an electromagnetic seal for sealing the coating tank at the bottom.

DE 195 35 854 A1 and DE 100 14 867 A1 offer special approaches to the solution of the problem of precise position control of the metal strand in the guide channel. According to the concepts disclosed there, the coils for inducing the electromagnetic traveling field are supplemented by correction coils, which are connected to an automatic control system and see to it that when the metal strip deviates from its center position, it is brought back into this position.

EP 0 630 421 B1 discloses a device for hot dip coating a metal strand, in which an electromagnetic sealing device is installed below the coating tank. It further provides for a premelting tank that is associated with the coating tank that holds the molten coating metal. The premelting tank has a capacity several times greater than the capacity of the coating tank. To allow the coating tank to be refilled or drained, it is connected with the premelting tank by feed and discharge channels. The molten coating material can be circulated between the precoating tank and the coating tank with the exclusion of atmospheric oxygen.

In accordance with this design, the premelting tank for the coating metal is arranged to the side of the actual coating tank. This arrangement of the premelting tank is especially favorable for new hot dip coating installations, which can be designed for optimum performance of the hot dip coating process.

JP 63[1988]-317, 656 A, JP 60[1985]-245, 774 A, and WO 93/18198 A likewise describe coating devices in which the metal strand to be coated is guided vertically through a guide channel.

The molten material necessary for the coating process is fed from a premelting tank to the coating tank through fluid-conveying lines.

EP 0 451 020 A1 describes a solution in which a seal is created at the bottom by a pair of interacting rolls, such that overflowing molten metal running down from a guide channel can collect in the roll gap.

It was found that the vertical coating process (also known as the CVGL process=Continuous Vertical Galvanizing Line process) is more favorable from the standpoint of process engineering than the conventional hot dip coating process, which works with stabilizing rollers and with a deflecting roller that runs in the molten coating metal. Therefore, there is the desire to retrofit existing hot dip coating installations to vertical coating installations. In this connection, it is important to consider especially the space conditions, which often necessitate conceptional compromises, which can lead to less than optimum process conditions.

Therefore, the objective of the invention is to create the possibility of retrofitting existing conventional hot dip coating installations in such a way that the vertical coating process can also be carried out in an optimum way and in such a way that the existing installation can be utilized to maximum advantage.

In accordance with the invention, this objective is achieved by arranging the premelting tank vertically below the guide channel, such that a] furnace snout that extends from a furnace is provided, from which the metal strand runs out in the feed direction; such that the metal strand is deflected into the vertical direction by at least two deflecting rollers and is fed to the guide channel; such that the line of intersection of the extension of the metal strand in the feed direction with the extension of the metal strand in the vertical direction through the guide channel is located below the level of the molten coating metal in the premelting tank, so that the pass line of the metal strand is not changed compared to the conventional process; and such that the premelting tank is suitable for holding a deflecting roller positioned in the molten coating metal.

Therefore, in accordance with the invention, the premelting tank is a tank that is suitable for carrying out the hot dip coating process in the conventional way.

A simple and inexpensive concept for the retrofitting or modernization of existing hot dip coating installations to the vertical coating process is created with this embodiment, in which, nevertheless, optimum process conditions can be realized. The coating tank for the hot dip coating, together with the upstream guide channel, is installed directly above the conventional installation and, specifically, above the coating tank of the conventional installation, which functions as a premelting tank. The coating tank, which has the deflecting roller immersed in the coating metal in the conventional process, is thus used as a premelting tank for the vertical coating installation.

The end of the furnace snout and the lower end of the guide channel are preferably connected with a gastight and heated roller chamber. In this regard, it can additionally be provided that a lock, especially a roller lock, be arranged between the end of the furnace snout and the roller chamber.

The device also preferably has an automatically controlled or regulated pump for pumping molten coating metal from the premelting tank into the coating tank. In addition, an outlet that can be automatically controlled or regulated can be provided for transferring molten coating metal from the coating tank to the premelting tank. Lines between the coating tank, the premelting tank, the pump and the outlet can be designed to be heated.

A deflecting roller that deflects the metal strand out of the vertical direction can be positioned above the coating tank. It is advantageous for this deflecting roller to be water-cooled to make it possible to get by with the cooling line above the coating tank of the coating installation that is to be retrofitted or modernized.

At least one of the existing deflecting rollers and the guide rollers, which have contact with the metal strand, can be provided with a ceramic coating that cannot be wetted by molten coating metal.

In accordance with the invention, the method for hot dip coating the metal strand in the vertical coating process, in which the coating tank is supplied with molten coating metal from a premelting tank, is characterized by the fact that to start the coating process, molten coating metal is fed from the premelting tank to the preheated coating tank, which initially is empty, while the metal strand is moving in the direction of conveyance, such that molten coating metal is transferred between the premelting tank and the coating tank by means of a pump and an outlet of the coating tank at a volume flow rate that is at least five times greater than the rate of removal of coating metal from the coating tank by the metal strand.

In this regard, it is advantageous to provide that before the start of the coating process, an atmosphere with a very low dew point, which promotes adhesion of the coating metal to the surface of the metal strand, be produced in the roller chamber by feeding a protective gas into the roller chamber and establishing a desired temperature in the roller chamber.

In accordance with another refinement of the invention, the metal strand is fed to the guide channel at a temperature of 450-530° C.

It can also be provided that the level height of the coating metal in the coating tank be automatically controlled or regulated to a preset value.

It is advantageous if molten coating metal is transferred between the premelting tank and the coating tank by means of the pump and the outlet of the coating tank at a volume flow rate that is significantly greater, preferably at least five times greater, than the rate of removal of coating metal from the coating tank by the metal strand.

New coating metal in solid form can be supplied to the premelting tank. Impurities can be removed from the premelting tank, preferably periodically.

A specific embodiment of the invention is illustrated in the sole drawing, which shows a schematic side view of a hot dip coating installation for coating a metal strand with coating metal.

The illustrated hot dip coating installation operates by the vertical coating process, i.e., the metal strand 1 runs in the direction of conveyance R vertically upward through a guide channel 4 and comes into contact with the molten coating metal 2, which is present in a coating tank 3 and in the upper portion of the guide channel 4.

It is noteworthy that this vertical coating installation is based on a retrofitted hot dip coating installation, in which the conventional hot dip coating process is carried out (with deflecting roller in the molten coating metal). In this regard, the metal strand 1 passes in a feed direction Z into a premelting tank 6 that contains molten coating metal 2. A deflecting roller 7 deflects the metal strand 1 in the vertical direction V. Above the tank 6, there is a blowing device 22, which constitutes an “air squeegee”, by which the coating thickness of the coating metal 2 on the metal strand 1 is adjusted. A cooling line 23, which cools the metal strand 1 together with the coating metal 2, is located above the blowing device 22.

The drawing shows that the line of intersection 12 of the extension of the metal strand 1 in the feed direction Z with the extension of the metal strand 1 in the vertical direction V through the guide channel 4 is located below the level 13 of the coating metal 2 in the premelting tank 6.

The two deflecting rollers 10 and 11 are thus arranged in such a way that the pass line of the metal strand 1 both in the furnace snout 9 and in the vertical part of the hot dip coating installation is not changed compared to the original conventional coating installation.

However, in the illustrated hot dip coating installation, the metal strand 1 does not enter the coating metal contained in the premelting tank 6, but rather it is deflected from the feed direction Z to the vertical direction V by the deflecting rollers 10 and 11, so that the metal strand 1 can enter the guide channel 4 above the deflecting roller 10 and the guide rollers 24. Electromagnetic inductors 5 hold back the coating metal 2 present in the coating tank 3, so that it cannot run down through the guide channel 4.

The deflecting roller 7 running in the molten metal 2 in the original installation is shown as a broken line, which is meant to show that it is no longer needed in the illustrated hot dip coating installation and therefore can be removed.

In this method, the metal strand 1 is first heated in a furnace 8 and conveyed in direction of conveyance R. It enters a roller chamber 14 (preferably electrically heated) through a furnace snout 9, which is also present in the original hot dip coating installation, and through a roller lock 15. The end of the furnace snout 9 and the lower end of the guide channel 4 are connected with each other by a gastight roller chamber 14. In the roller chamber 14, the metal strand 1 is maintained at the temperature T established in the furnace.

The purpose of the twin-roller lock 15 is to separate the different protective gas atmospheres in the furnace, on the one hand, and in the roller chamber 14, on the other hand, and to prevent air from the roller chamber 14 from entering the furnace 8 in the event of a disruption. In addition, it has an important process-engineering function during the start-up of the hot dip coating installation: The sealing of the protective gas atmosphere in the roller chamber 14 makes it possible to reach the low dew point necessary for the coating process within a short time. As a result, satisfactory adhesion of the coating metal 2 to the metal strand 1 can be achieved within a very short amount of time after the coating tank 3 has been filled with the coating metal 2, which is an important advantage over the conventional hot dip coating process.

The lock 15 can be filled with nitrogen or another protective gas, so that the necessary sealing of the atmosphere of the roller chamber 14 from the atmosphere in the furnace 8 can be effected. The roller chamber 14 is likewise filled with protective gas. Nitrogen, forming gas (nitrogen with a maximum of 5% hydrogen), or a protective gas of low thermal conductivity (e.g., argon) is preferably used for this purpose.

The tank 6 of the original hot dip coating installation serves as the premelting tank, i.e., molten coating metal 2 is pumped from the premelting tank 6 into the coating tank 3 through an automatically controlled or regulated pump 16 that is submerged in the molten metal and through a heatable line 19. An automatically controlled or regulated outlet 17 is located in the bottom of the coating tank 3. It consists of a controllable plug that can be moved in the direction of the double arrow. Coating metal 2 can be returned from the coating tank 3 to the premelting tank 6 through the outlet 17 and another heatable line 20.

A desired level height h of coating metal 2 can be maintained in the coating tank 3 by suitable control of the pump 16 and the outlet 17. The movement of coating metal 2 in lines 19 and 20 is indicated schematically by arrows.

A liquid-cooled deflecting roller 21 is provided above the hot dip coating installation and the air cooling line 23. It deflects the metal strand from the vertical direction V to the. direction of conveyance R away from the hot dip coating installation.

The pump 16 is located at the side below the roller chamber. The pump 16 is submerged in the molten coating metal 2 in the premelting tank 6.

The volume of the premelting tank 6 is several times greater than the volume of the coating tank 3.

The return line 20 for molten coating metal 2 from the coating tank 3 to the premelting tank 6 terminates below the level 13 in the premelting tank 6.

The amount of molten coating metal 2 pumped by the pump 16 from the premelting tank 6 to the coating tank 3 is preferably more or less constant. This results in a constant circulation of coating metal, so that fresh coating metal that is free of impurities is constantly pumped from the premelting tank 6 to the coating tank 3. The temperature of the coating metal 2 is controlled in the premelting tank 6, whose level 13 is continuously controlled or held constant by melting down ingots of solid coating metal. The level 13 in the premelting tank 6 is adjusted in such a way that in the event of a disruption of the hot dip coating installation, the entire amount of coating metal 2 in coating tank 3 can be received by the premelting tank 6.

As in the case of a conventional hot dip coating installation, the “air squeegee” 22 and the cooling line 23 are located above the coating tank 3. The capacity of the air cooling line 23 is adjusted accordingly. A deflecting roller 21 that is internally cooled with water can be used as an additional measure for cooling the metal strand 1.

The premelting tank 6 is equipped with a charging device (not shown), by which solid ingots of coating metal can be introduced into the premelting tank 6 to be melted down.

The cleaned metal strand 1 to be coated, which consists of hot-rolled or cold-rolled steel, is fed into the roller chamber 14 at a temperature of 450-530° C. (in the case of coating with zinc) through the end zone of the furnace 8 and the furnace snout 9 and through the lock 15, which is filled with protective gas. At the beginning of the coating process, the coating tank 3 is initially still empty, i.e., it initially contains no coating metal 2.

After the metal strand 1 starts to move in direction of conveyance R, the pump 16 starts to pump molten coating metal 2 from the premelting tank 6 to the coating tank 3. Prior to this, the electromagnetic inductors 5 were activated, so that the coating metal 2 pumped into the coating tank 3 is held back in the coating tank 3 and cannot run out at the bottom.

The desired level height h in the coating tank 3 is then maintained by suitable control or regulation of both the pump 16 and the outlet 17.

The level height h in the tank 3 is automatically controlled or regulated as a function of the strip speed and the desired coating quality. In this regard, the molten coating metal 2 is fed by the pump 16 into the coating tank 3 at a rate that is as constant as possible, and molten coating metal 2 is allowed to flow out of the outlet 17 at a suitably controlled or regulated rate.

The amount of molten coating metal 2 circulated between the premelting tank 6 and the coating tank 3 by this pumping and draining process is several times greater than the amount of coating metal removed from the coating tank 3 as coating material on the metal strand 1 per unit time.

Fresh and clean coating metal is continuously supplied to the coating tank 3 by the pumping of molten coating metal 2 from the premelting tank 6 to the coating tank 3. Impurities, especially spelter, can be separated in the premelting tank 6 and then removed from it at desired intervals of time.

### List of Reference Symbols

1 metal strand
2 molten coating metal
3 coating tank
4 guide channel
5 inductor (magnet)
6 premelting tank
7 deflecting roller
8 furnace
9 furnace snout
10 deflecting roller
11 deflecting roller
12 line of intersection
13 level
14 roller chamber
15 lock (roller lock)
16 pump
17 outlet
18
19 line
20 line
21 deflecting roller
22 blowing device
23 cooling line
24 guide rollers
Z feed direction
V vertical direction
T temperature
h level height
R direction of conveyance of the metal strand

1. Device for hot dip coating a metal strand (1), especially a steel strip, in which the metal strand (1) can be vertically guided through a coating tank (3) that contains the molten coating metal (2) and through a guide channel (4) upstream of the coating tank (3), wherein electromagnetic inductors (5) are arranged in the area of the guide channel (4) and induce a magnetic field for keeping the coating metal (2) in the coating tank (3), and wherein the coating tank (3) is supplied with molten coating metal (2) from a premelting tank (6), characterized by the fact that the premelting tank (6) is arranged below the guide channel (4).

2. Device in accordance with claim 1, characterized by the fact that the premelting tank (6) is designed for holding a deflecting roller (7) that is positioned in the molten coating metal (2).

3. Device in accordance with claim 1 or claim 2, characterized by a furnace snout (9) that extends from a furnace (8), from which the metal strand (1) runs out in a feed direction (Z), such that the metal strand (1) is deflected into the vertical direction (V) by at least one and preferably two deflecting rollers (10, 11) and is fed into the guide channel (4).

4. Device in accordance with claim 3, characterized by the fact that the line of intersection (12) of the extension of the metal strand (1) in the feed direction (Z) with the extension of the metal strand (1) in the vertical direction (V) through the guide channel (4) is located below the level (13) of the molten coating metal (2) in the premelting tank (6), so that the pass line of the metal strand (1) is not changed compared to the conventional process.

5. Device in accordance with claim 3 or claim 4, characterized by the fact that the end of the furnace snout (9) and the lower end of the guide channel (4) are connected with a gastight roller chamber (14).

6. Device in accordance with claim 5, characterized by the fact that a lock (15), especially a roller lock, is arranged between the end of the furnace snout (9) and the roller chamber (14).

7. Device in accordance with any of claims 1 to 6, characterized by an automatically controlled or regulated pump (16) for pumping molten coating metal (2) from the premelting tank (6) into the coating tank (3).

8. Device in accordance with claim 7, characterized by an automatically controlled or regulated outlet (17) for transferring molten coating metal (2) from the coating tank (3) to the premelting tank (6).

9. Device in accordance with claim 7 or claim 8, characterized by the fact that lines (19, 20) between the coating tank (3), the premelting tank (6), the pump (16), and/or the outlet (17) are designed to be heated.

10. Device in accordance with any of claims 1 to 9, characterized by the fact that a deflecting roller (21) that deflects the metal strand (1) out of the vertical direction (V) is positioned above the coating tank (3).

11. Device in accordance with any of claims 3 to 10, characterized by the fact that at least one of the deflecting rollers (10, 11, 21) and the guide rollers (24) are provided with a ceramic coating that cannot be wetted by molten coating metal (2).

12. Method for hot dip coating a metal strand (1), especially a steel strip, in which the metal strand (1) can be vertically guided through a coating tank (3) that contains the molten coating metal (2) and through a guide channel (4) upstream of the coating tank (3), wherein a magnetic field, especially an electromagnetic field, is induced in the area of the guide channel (4) to keep the coating metal (2) in the coating tank (3), wherein the coating tank (3) is supplied with molten coating metal (2) from a premelting tank (6), and wherein a device in accordance with any of claims 1 to 11 is used, characterized by the fact that to start the coating process, molten coating metal (2) is fed from the premelting tank (6) to the preheated coating tank (3), which initially is empty, while the metal strand (1) is moving in the direction of conveyance (R).

13. Method in accordance with claim 12, characterized by the fact that before the start of the coating process, an atmosphere that promotes adhesion of the coating metal (2) to the surface of the metal strand (1), is produced in the roller chamber (14) by feeding a protective gas into the roller chamber (14) and/or establishing a desired temperature (T) in the roller chamber (14).

14. Method in accordance with claim 12 or claim 13, characterized by the fact that the metal strand (1) is fed into the guide channel (4) at a temperature of 450-530° C. in the case of coating with zinc.

15. Method in accordance with any of claims 12 to 14, characterized by the fact that the level height (h) of the coating metal (2) in the coating tank (3) is automatically controlled or regulated to a preset value.

16. Method in accordance with any of claims 12 to 15, characterized by the fact that molten coating metal (2) is transferred between the premelting tank (6) and the coating tank (3) by means of the pump (16) and the outlet (17) of the coating tank (3) at a volume flow rate that is significantly greater, preferably at least five times greater, than the rate of removal of coating metal (2) from the coating tank (3) by the metal strand (1).

17. Method in accordance with any of claims 12 to 16, characterized by the fact that impurities are removed from the premelting tank (6), preferably periodically.
